(19) United States
(12) Patent Application Publication
(10) Pub. No.: US 2005/0171992 A1
(43) Pub. Date: Aug. 4, 2005

(54) Signal processing apparatus, and voltage or current measurer utilizing the same

(75) Inventors: Ryohei Tanaka, Osaka-shi (JP); Toyokazu Kitano, Osaka-shi (JP)

Correspondence Address: Douglas P. Mueller;MERCHANT & GOULD P.C., 3200 IDS Center, 80 South 8th Street, Minneapolis, MN, 55402-2215, US

(73) Assignee: DAIHEN CORPORATION, Osaka-shi (JP)

(21) Appl. No.: 11/048,434

(22) Filed: Jan. 31, 2005

(30) Foreign Application Priority Data
Feb. 2, 2004 (JP) 2004-025653

(51) Int. Cl. G06G 7/02

(52) U.S. Cl. 708/819

(57) ABSTRACT

A signal processing apparatus produces a signal representing the effective value of an inputted alternating signal. The apparatus includes a square calculator, a filter and a square-root calculator. The square calculator produces a square signal representing several squared values of the inputted alternating signal. The filter extracts a DC component signal from the square signal. The square-root calculator produces a signal representing the square root of a level value of the extracted DC component signal.

### BACKGROUND OF THE INVENTION

1. Field of the Invention

The present invention relates to a signal processing apparatus designed to process an alternating signal, such as a voltage signal and a current signal, for producing a signal indicating the effective value of the alternating signal inputted. The present invention also relates to a voltage measurer or a current measurer utilizing such a signal processing apparatus.

2. Description of the Related Art

As conventionally known, the effective value (root-mean-square value) Arms of a sinusoidal signal Am·sin(ωt+φ) is calculated by the following formula (1).

$$\begin{matrix}Arms = Am \sqrt{\frac{1}{T} {\int }_{0}^{T} {sin}^{2} ( ω t + φ ) ⅆ t} \\ = \frac{Am}{\sqrt{2}}\end{matrix} \qquad ( 1 )$$

In the similar manner, it is possible to calculate the effective-value-indicating signal (called “effective value signal” below) of an arbitrary alternating signal with the use of a conventionally available calculator. Specifically, first the original alternating signal is squared, and the signal squared is integrated with respect to t varying from zero to the period T. Then, after the integrated value is divided by the period T, the square root of the quotient is calculated.

In accordance with the above method, the signal processing for producing effective values includes the integration of a squared signal over a period and the calculation of the square root for the integrated value. Accordingly, the effective value calculation unfavorably takes at least the time corresponding to one period of the alternating signal.

In certain applications, an analog alternating signal is converted into a corresponding digital signal by an A/D (Analog to Digital) converter. Based on this digital signal, a digital effective value signal can be calculated through a known digital processing technique. Specifically, supposing that a digital alternating signal is constituted by a number of pieces of sampling data D[n] (n=1, 2, 3, . . . ), each sampling data D[n] is squared by a square calculator. Then, all the pieces of the squared data D[n]² for one period are totaled by an integrator to produce Σ(D[n] ²). Finally, the square root of Σ(D[n]²) is calculated by a square-root calculator.

In this method, however, the result of the effective value calculation may vary depending on the sampling points for one period of the alternating signal. For overcoming this problem, several effective values for the corresponding number of periods may be calculated, and then the mean value of these effective values is calculated to produce a more accurate measurement result.

More detailed information about conventional techniques as described above may be available from JP-A-H10-170556 or JP-A-H10-185966, for example.

In the above-described digital processing, effective values for more than one period are obtained, and then the mean value of those effective values is calculated. In this manner, the accuracy of effective value estimation may be improved. However, the number of steps required for producing the final result tends to increase, whereby the entire calculation takes an unduly long time.

Further, digital signal processing for producing the effective value of a high-frequency signal (in a MHz band, for example) would require a high sampling frequency for obtaining a sufficiently accurate effective value. As the sampling frequency increases, the number of sampling data contained in one wavelength decrease, whereby a plurality of waves would need to be observed. Also, it is not easy to determine, based on the sampling data, where the starting point of a period of the sinusoidal wave is. In view of these, the effective value calculation is not performed in the digital signal processing circuit. Instead, the digital signal is converted back into a high-frequency analog signal, and then the effective value calculation is performed by analog signal processing.

This method, however, requires a complicated circuit structure for performing complicated signal processing.

### SUMMARY OF THE INVENTION

The present invention has been proposed under the circumstances described above. It is, therefore, an object of the present invention to provide a signal processing apparatus having a simple circuit but being capable of producing a reliable effective value of an alternating signal. Another object of the present invention is to provide a voltage or current measurer using such a signal processing apparatus.

According to a first aspect of the present invention, there is provided a signal processing apparatus for producing a signal representing the effective value of an inputted alternating signal. The processing apparatus comprises: a square calculator for producing a square signal representing squared values of the inputted alternating signal; a filter for extracting a DC component signal from the square signal; and a square-root calculator for producing a signal representing a square root of a level value of the extracted DC component signal.

Preferably, the filter may comprise a plurality of filtering units connected in cascade, each filtering unit having a single resonance frequency.

According to a second aspect of the present invention, there is provided a voltage measurer comprising: a detector for detecting an alternating voltage signal; and a signal processing apparatus according to the first aspect of the present invention described above. The voltage signal detected by the detector is processed by the signal processing apparatus to produce a signal representing the effective value of the voltage signal.

According to a third aspect of the present invention, there is provided a current measurer comprising: a detector for detecting an alternating current signal; and a signal processing apparatus according to the first aspect of the present invention. The current signal detected by the detector is processed by the signal processing apparatus to produce a signal representing the effective value of the current signal.

According to a fourth aspect of the present invention, there is provided a signal processing apparatus for producing a signal representing the effective vale of an inputted analog alternating signal. The processing apparatus comprises: a signal converter for sampling the inputted alternating signal at predetermined sampling points to output a digital signal representing level values of the alternating signal at the respective sampling points; a square calculator for producing a digital signal representing a square value of each level value of the alternating signal; a digital filter for extracting a DC component signal from the digital signal produced by the square calculator; and a square-root calculator for producing a digital signal representing a square root of a level value of the extracted DC component signal.

Preferably, the digital filter may comprise a plurality of filtering units connected in cascade, each filtering unit having a single resonance frequency.

According to a fifth aspect of the present invention, there is provided a voltage measurer comprising: a detector for detecting an alternating voltage signal; and a signal processing apparatus according to the fourth aspect of the present invention described above. The voltage signal detected by the detector is processed by the signal processing apparatus to produce a signal representing an effective value of the voltage signal.

According to a sixth aspect of the present invention, there is provided a current measurer comprising: a detector for detecting an alternating current signal; and a signal processing apparatus according to the fourth aspect of the present invention. The current signal detected by the detector is processed by the signal processing apparatus to produce a signal representing an effective value of the current signal.

Other features and advantages of the present invention will become apparent from the detailed description given below with reference to the accompanying drawings.

### BRIEF DESCRIPTION OF THE DRAWINGS

FIG. 1 is a block diagram illustrating the basic components of a signal processing apparatus according to the present invention;

FIG. 2 illustrates the basic components of the square calculator used in the apparatus of FIG. 1;

FIG. 3 illustrates the basic components of the digital filter used in the apparatus of FIG. 1;

FIG. 4 illustrates the components of a squared alternating signal and the characteristics of the digital filter;

FIG. 5A illustrates the waveforms of sampling data inputted to and outputted from the square calculator;

FIG. 5B illustrates the waveform of the sampling data outputted from the digital filter;

FIG. 6 is a block diagram showing the formation of a plasma processing system including a voltage/current measurer which uses the signal processing apparatus of the present invention;

FIG. 7 is a block diagram showing the basic formation of the voltage/current measurer; and

FIG. 8 is a block diagram showing the basic formation of the digital signal processing unit used in the voltage/current measurer.

### DETAILED DESCRIPTION OF THE PREFERRED EMBODIMENTS

Preferred embodiments of the present invention will be described below with reference to the accompanying drawings.

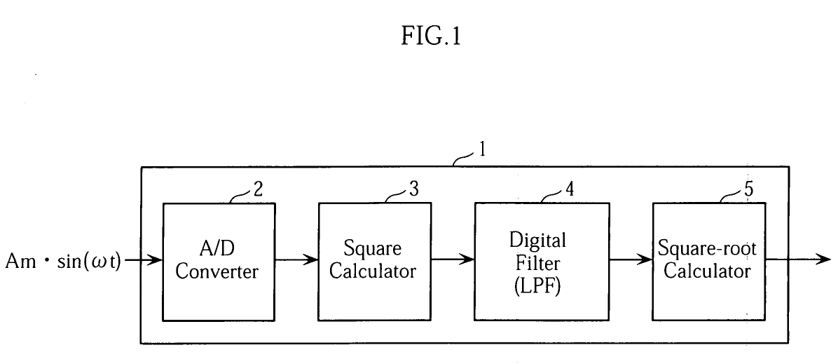

Referring first to FIG. 1, a signal processing apparatus 1 according to the present invention is designed to calculate the effective value of a inputted alternating signal by digital signal processing. As shown in the figure, the signal processing apparatus 1 includes an A/D converter 2, a square calculator 3, a digital filter 4 and a square-root calculator 5.

The A/D converter 2 converts an inputted analog alternating signal into a digital alternating signal. More specifically, the A/D converter 2 samples the analog input signal at predetermined intervals and converts each of the detected level values into digital data (“sampling data”) of a predetermined number of bits. The above-mentioned digital alternating signal is made up of these pieces of sampling data. This digital signal is inputted to the square calculator 3.

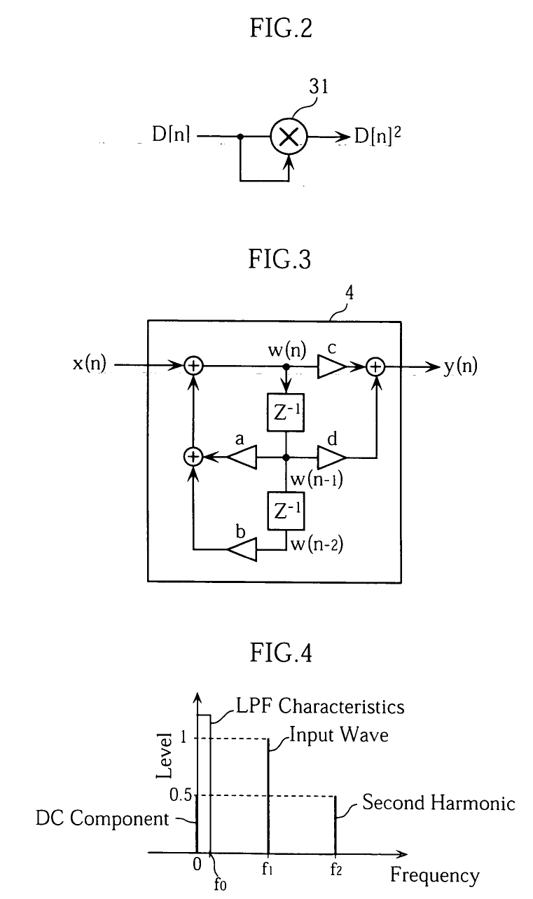

The square calculator 3 calculates the square of the levels represented by the respective pieces of sampling data sent from the A/D converter 2, and then produces a digital signal representing the squared values (numeral data in a predetermined number of bits). As shown in FIG. 2, the square calculator 3 includes a multiplier 31 into which sampling data D[n] is inputted via two different routes. Then, the multiplier 31 calculates D[n]²=D[n]×D[n] to be outputted as numeral data in a predetermined number of bits. The squared data D[n] ² is inputted to the digital filter 4.

As shown in FIG. 3, the digital filter 4 is an IIR (infinite impulse response) low-pass filter which removes signals whose frequency is higher than a given cutoff frequency.

The low-pass filter 4 shown in FIG. 3 is a second-order IIR low-pass filter having two feedback parts. As conventionally known, the cutoff frequency f₀ (see FIG. 4) is determined by the coefficient a, while the attenuation at the cutoff frequency is determined by the coefficient b. In the filter 4 of the present embodiment, the coefficient a is so determined that the cutoff frequency f₀ falls in a range of 1˜9 Hz, for example. Accordingly, substantially only the DC (direct current) component of the squared alternating signal can pass through the filter 4.

More specifically, supposing that the alternating signal inputted to the signal processing apparatus 1 is Am·sin(ωt), the squared signal {Am·sin(ωt)}² is inputted to the digital filter 4 from the square calculator 2. Since {Am·sin(ωt)}²=Am²/2+{Am²·cos(2ωt)}/2, the digital filter 4 receives a DC component (Am²/2) and a second harmonic ({Am²·cos(2ωt)}/2). The DC component is allowed to pass though the filter, but the second harmonic is blocked. In this manner, sampling data representing the level value Am²/2 is obtained.

In the above-described embodiment, the digital filter 4 comprises only one IIR low-pass filter having a single resonance frequency. According to the present invention, however, use may be made of a digital filter comprising a plurality of IIR low-pass filter units connected to each other (specifically, connected in cascade) so that its pass band becomes narrower.

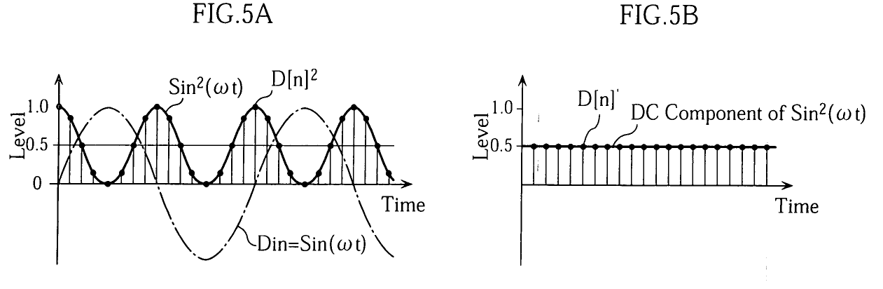

FIG. 5A shows the waveforms of sampling data inputted to and outputted from the square calculator 3. FIG. 5B shows the waveform of the sampling data outputted from the digital filter 4. In these figures, the amplitude Am of the illustrated signals is normalized (i.e., |Am|=1).

As seen from FIG. 5A, upon receiving the sampling data D[n] of the alternating signal sin(ωt), the square calculator 3 outputs a signal having a level of D[n]². This outputted signal is then sent to the digital filter 4. Since the output of the second harmonic {cos(2 ωt)}/2 is much smaller than DC component and close to zero, the filter 4 seems to output only the digital data of the DC component (½), that is, digital data D[n]′ whose level is 0.5.

Referring back to FIG. 1, the square-root calculator 5 calculates the square root of the sampling data D[n]′ outputted from the digital filter 4. For instance, when the level of the data D[n]′ is equal to 0.5 (as shown in FIG. 5B), the square-root calculator 5 outputs a signal whose level is 0.707 (˜\sqrt{0.5}).

As described above, in the signal processing apparatus 1, the DC component Am²/2 of a squared alternating signal is extracted, and its square root is calculated. The result is Am/\sqrt{2}, which is equal to the effective value of the alternating signal Am·sin(ωt) (˜0.707×Am).

According to the present invention, the above result Am/\sqrt{2} is obtained without performing time-consuming calculations such as the integration of D[n]² over a period T and working out the mean value of the integrations. Accordingly, it is possible to obtain an accurate effective value of the alternating signal by a simple digital processing apparatus.

Further, according to the present invention, the apparatus 1 calculates the effective value of sampling data D[n] immediately after the sampling data D[n] is inputted. Thus, even if the alternating signal is a high-frequency wave, a reliable effective value can be determined at an early stage.

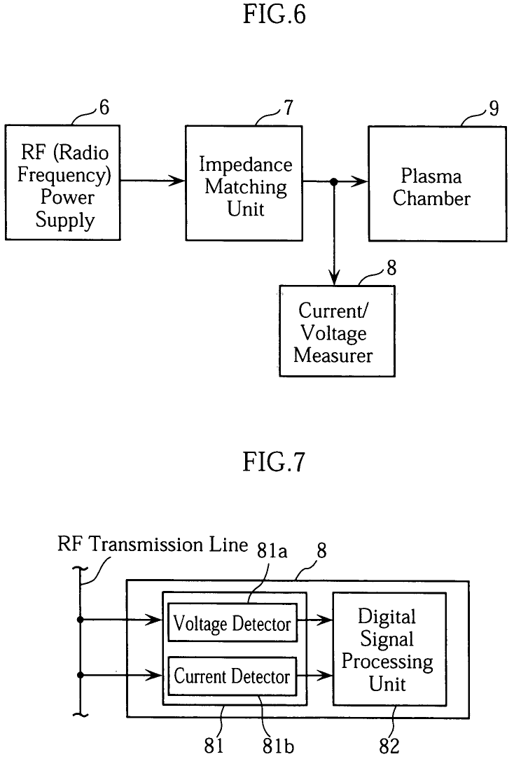

FIG. 6 shows a plasma processing system to which the above-described signal processing apparatus 1 is applicable. Specifically, the plasma processing system includes a Radio-frequency power supply 6, an impedance matching unit 7, a voltage/current measurer 8 and a plasma chamber 9. The power supply 6 supplies a required high-frequency wave to the plasma chamber 9 via the impedance matching unit 7. In the plasma chamber 9, a semiconductor wafer is subjected to plasma etching. The voltage/current measurer 8, arranged between the impedance matching unit 7 and the plasma chamber 9, detects a high-frequency voltage or current signal at the input terminals of the plasma chamber 9. The signal processing apparatus 1 of the present invention can be used in the v/c measurer 8.

As shown in FIG. 7, the v/c measurer 8 comprises an analog signal processor 81 and a digital signal processing unit 82. The analog signal processor 81 includes a voltage detector 81a to detect an alternating voltage signal and a current detector 81b to detect an alternating current signal. The alternating analog signal (voltage or current signal) outputted from the analog signal processor 81 is supplied to the digital signal processing unit 82 to be converted into a digital signal based on which the effective value Vrms of the voltage signal or the effective value Irms of the current signal is calculated.

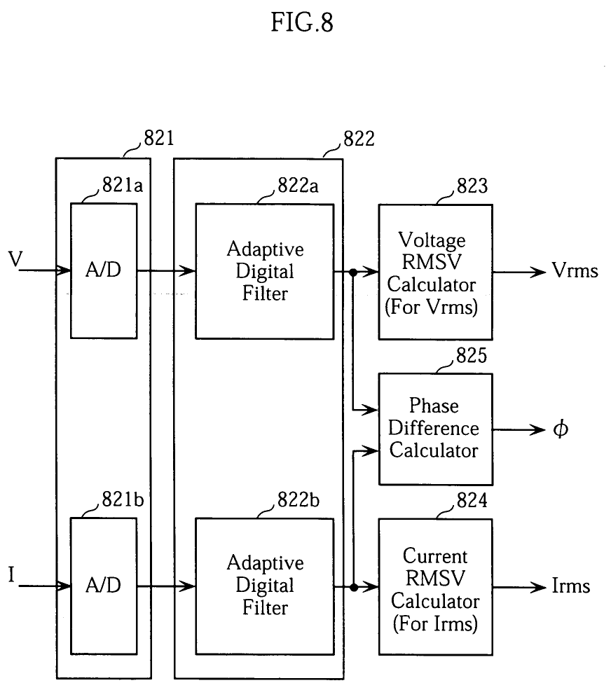

As shown in FIG. 8, the digital signal processing unit 82 comprises an A/D converting unit 821, a digital filtering unit 822, a voltage RMSV (root-mean square value) calculating unit or calculator 823, a current RMSV calculating unit 824, and a phase difference calculating unit 825. The A/D converting unit 821 converts an analog signal (supplied from the analog signal processor 81) into a digital signal. The digital filtering unit 822 extracts an alternating signal of a desired frequency from the digital signal outputted from the A/D converting unit 821. The voltage RMSV calculating unit 823 calculates the root-mean square value Vrms of the extracted voltage signal, while the current RMSV calculating unit 824 calculates the root-mean square value Irms of the extracted current signal. The phase difference calculating unit 825 calculates the phase difference φ between the extracted voltage signal and the extracted current signal.

The A/D converting unit 821 includes two A/D converting circuits: a first A/D converting circuit 821a for an alternating voltage signal and a second A/D converting circuit 821b for an alternating current signal. Likewise, the digital filtering unit 822 includes two adoptive digital filters: a first digital filter 822a to pass an alternating voltage signal of a desired frequency and a second digital filter 822b to pass an alternating current signal of a desired frequency. The desired frequency mentioned here is the frequency of the high-frequency power outputted from the RF power supply 6 used for the plasma processing system. In the illustrated example, the desired frequency is 13.56 MHz, for example.

Each of the filters 822a, 822b is a filter whose resonance frequency can be adjusted to follow a prescribed frequency in the same manner as the IIR digital filter 4 of FIG. 3, in which the resonance frequency f₀ can be changed by altering the coefficient a. An example of an adoptive digital filter is disclosed in JP-A-H06-188683, for example.

In addition to the above-described function of the IIR digital filter 4, the adoptive digital filters shown in FIG. 8 are provided with a coefficient feedback function to be implemented by a coefficient control circuit (not shown). Specifically, every time a piece of sampling data is inputted, the coefficient control circuit calculates a coefficient a used to perform filtering of the next piece of sampling data. This calculated coefficient is fed back by the coefficient control circuit.

In accordance with the v/c measurer 8 shown in FIG. 7, the voltage detector 81a detects a high-frequency voltage signal at the input terminal of the plasma chamber 9, and this detected signal is subjected to prescribed analog signal processing (for example, level adjustment, noise-removing, etc.). Then, the signal is inputted to the digital signal processing unit 82. In the signal processing unit 82, the analog voltage signal is converted into a digital voltage signal (sampling data V[n]) by the first A/D converting circuit 821a. Thereafter, the adoptive digital filter 822a extracts a voltage signal of the desired frequency fd (13.56 MHz in the illustrated example). The extracted voltage signal is inputted to the voltage RMSV calculating unit 823 and the phase difference calculating unit 825.

Similarly, the current detector 81b detects a high-frequency current signal at the input terminal of the plasma chamber 9, and this detected signal is subjected to the same analog signal processing as described above. Then, the signal is inputted to the digital signal processing unit 82. In the signal processing unit 82, the analog current signal is converted into a digital current signal (sampling data I[n]) by the second A/D converting circuit 821b. Thereafter, the adoptive digital filter 822b extracts a current signal of the desired frequency fd (13.56 MHz in the illustrated example). The extracted current signal is inputted to the current RMSV calculating unit 824 and the phase difference calculating unit 825.

After receiving the voltage signal from the adoptive digital filter 822a, the voltage RMSV calculating unit 823 produces digital data representing the effective value Vrms of the voltage signal V of 13.56 MHz. Likewise, after receiving the current signal from the adoptive digital filter 822b, the current RMSV calculating unit 824 produces digital data representing the effective value Irms of the current signal I of 13.56 MHz. Thereafter, the phase difference calculating unit 825 calculates the phase difference φ between the voltage signal V and the current signal I, and outputs digital data representing the calculation result.

In the above explanation, the present invention is applied to digital signal processing. However, it can also be applied to analog signal processing. In this case, the square calculator 3 shown in FIG. 1 may be replaced with a signal square circuit comprising a non-linear amplifier having second-power characteristics. Further, the digital filter 4 may be replaced with an analog filter permitting the passage of DC components only, and the square-root calculator 5 may be replaced with a level converting circuit designed to convert the level of a DC signal from the analog filter into the square-root value.

When such analog signal processing is adopted, an input analog signal S=Am·sin(ωt) is converted into S²={Am·sin(ωt)}² by the signal square circuit. Then, the analog filter extracts only the DC component Am²/2 from S²={Am·sin(ωt)}². Thereafter, the level converting circuit calculates and outputs the square root of the DC component, that is, Am/\sqrt{2}.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A signal processing apparatus for producing a signal representing an effective value of an inputted alternating signal, the apparatus comprising:
a square calculator for producing a square signal representing squared values of the inputted alternating signal;
a filter for extracting a DC component signal from the square signal; and
a square-root calculator for producing a signal representing a square root of a level value of the extracted DC component signal.

2. The signal processing apparatus according to claim 1, wherein the filter comprises a plurality of filtering units connected in cascade, each filtering unit having a single resonance frequency.

3. A voltage measurer comprising:
a detector for detecting an alternating voltage signal; and
a signal processing apparatus according to claim 1;
wherein the voltage signal detected by the detector is processed by the signal processing apparatus to produce a signal representing an effective value of the voltage signal.

4. A current measurer comprising:
a detector for detecting an alternating current signal; and
a signal processing apparatus according to claim 1;
wherein the current signal detected by the detector is processed by the signal processing apparatus to produce a signal representing an effective value of the current signal.

5. A signal processing apparatus for producing a signal representing an effective vale of an inputted analog alternating signal, the apparatus comprising:
a signal converter for sampling the inputted alternating signal at predetermined sampling points to output a digital signal representing level values of the alternating signal at the respective sampling points;
a square calculator for producing a digital signal representing a square value of each level value of the alternating signal;
a digital filter for extracting a DC component signal from the digital signal produced by the square calculator; and
a square-root calculator for producing a digital signal representing a square root of a level value of the extracted DC component signal.

6. The signal processing apparatus according to claim 5, wherein the digital filter comprises a plurality of filtering units connected in cascade, each filtering unit having a single resonance frequency.

7. A voltage measurer comprising:
a detector for detecting an alternating voltage signal; and
a signal processing apparatus according to claim 5;
wherein the voltage signal detected by the detector is processed by the signal processing apparatus to produce a signal representing an effective value of the voltage signal.

8. A current measurer comprising:
a detector for detecting an alternating current signal; and
a signal processing apparatus according to claim 5;
wherein the current signal detected by the detector is processed by the signal processing apparatus to produce a signal representing an effective value of the current signal.
